(19) United States
(12) Patent Application Publication
(10) Pub. No.: US 2026/0288381 A1
(43) Pub. Date: Sep. 24, 2026

(54) IMAGE PROCESSING APPARATUS, IMAGE PROCESSING SYSTEM, NON-TRANSITORY COMPUTER READABLE MEDIUM, AND IMAGE PROCESSING METHOD

(71) Applicant: FUJIFILM Business Innovation Corp., Tokyo (JP)

(72) Inventor: Tetsuya KOBAYASHI, Kanagawa (JP)

(73) Assignee: FUJIFILM Business Innovation Corp., Tokyo (JP)

(21) Appl. No.: 19/268,602

(22) Filed: Jul. 14, 2025

(30) Foreign Application Priority Data
Mar. 18, 2025 (JP) 2025-043263

(51) Int. Cl. G06F 3/12

(52) U.S. Cl. CPC G06F 3/1204; G06F 3/1253; G06F 3/1273

(57) ABSTRACT

An image processing apparatus includes a processor configured to: extract a user's intention about a print setting from conversation data between the user and a conversation partner; and propose, to the user, information about change of the print setting, the change being inferred from the extracted intention.

### CROSS-REFERENCE TO RELATED APPLICATIONS

This application is based on and claims priority under 35 USC 119 from Japanese Patent Application No. 2025-043263 filed Mar. 18, 2025.

### BACKGROUND

### (i) Technical Field

The present disclosure relates to an image processing apparatus, an image processing system, a non-transitory computer readable medium, and an image processing method.

### (ii) Related Art

A technique is known in which a print process is performed by using print settings registered in advance through an operation performed by a user (for example, see Japanese Unexamined Patent Application Publication No. 2003-208299). A technique is known in which a user's history of past print processes is reflected to the user's print settings (for example, see Japanese Unexamined Patent Application Publication No. 2012-125935).

However, there are various users who perform printing by using printers, such as a person who wants to save time and labor of operations for registering print settings of a printer, a person who does not know how to register print settings satisfying their intention, and a person who is not good at operations themselves of a printer. In addition, if a user's history of print processes is simply reflected to the user's print settings, print settings which do not satisfy the user's intention may be registered.

### SUMMARY

Aspects of non-limiting embodiments of the present disclosure relate to a technique in which a print setting satisfying a user's intention may be registered with a reduction of the user's operational burden, compared with the case in which a print setting is registered through an operation by a user themselves or the case in which a user's history of print processes is simply reflected to print settings for the user.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image processing apparatus comprising a processor configured to: extract a user's intention about a print setting from conversation data between the user and a conversation partner; and propose, to the user, information about change of the print setting, the change being inferred from the extracted intention.

### BRIEF DESCRIPTION OF THE DRAWINGS

Exemplary embodiment of the present disclosure will be described in detail based on the following figures, wherein:

FIG. 1 is a diagram illustrating an exemplary overall configuration of an image processing system to which the present exemplary embodiment is applied;

FIG. 2 is a diagram illustrating an exemplary hardware configuration of a management server to which the present exemplary embodiment is applied;

FIG. 3 is a diagram illustrating an exemplary hardware configuration of an image processing apparatus to which the present exemplary embodiment is applied;

FIG. 4 is a diagram illustrating an exemplary functional configuration of a controller of a management server;

FIG. 5 is a flowchart of an exemplary process before print settings are changed, among the processes of a management server;

FIG. 6 is a flowchart of an exemplary process after print settings are changed, among the processes of a management server;

FIG. 7 is a diagram illustrating a concrete example of profile information;

FIG. 8 is a diagram illustrating a concrete example of conversation data between users and conversation partners;

FIG. 9 is a diagram illustrating a concrete example of conversation data between users and conversation partners;

FIG. 10 is a diagram illustrating concrete examples of conversation data between users and conversation partners;

FIG. 11 is a diagram illustrating a concrete example of conversation data between a user and a conversation partner;

FIG. 12 is a diagram illustrating a concrete example of conversation data between a user and conversation partners; and

FIG. 13 is a diagram illustrating a concrete example of conversation data between a user and conversation partners.

### DETAILED DESCRIPTION

Referring to the attached drawings, an exemplary embodiment of the present disclosure will be described below in detail.

### Configuration of Image Processing System 1

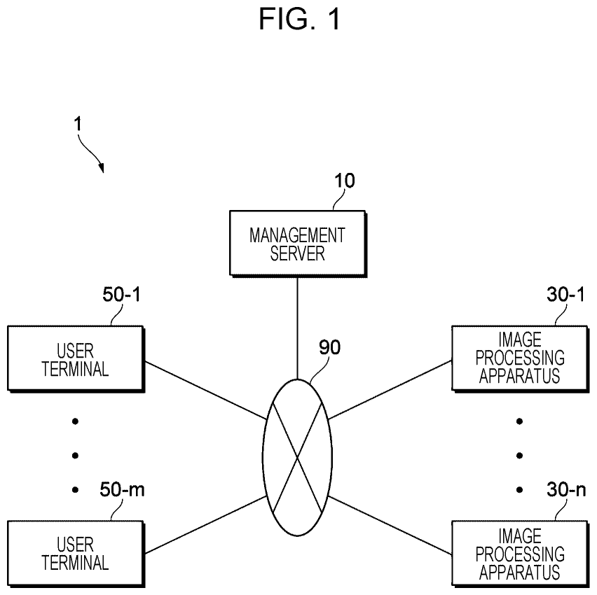

FIG. 1 is a diagram illustrating an exemplary overall configuration of an image processing system 1 to which the present exemplary embodiment is applied.

The image processing system 1 implements registration of a print setting, which satisfies a user's intention, with a reduction of the user's operational burden. The image processing system 1 has a configuration in which a management server 10, image processing apparatuses 30-1 to 30-n (n is an integer greater than or equal to one), and user terminals 50-1 to 50-m (m is an integer greater than or equal to one) are connected to one another over a network 90. Examples of the network 90 include a local area network (LAN) and the Internet. Hereinafter, when the image processing apparatuses 30-1 to 30-n are not necessarily described individually, these are collectively called image processing apparatuses 30. When the user terminals 50-1 to 50-m are not necessarily described individually, these are collectively called user terminals 50.

### Management Server 10

The management server 10 is an information processing apparatus functioning as a server which manages the entire image processing system 1. The management server 10 is managed, for example, by an operator of the image processing system 1. The management server 10 is capable of transmitting, for execution of various processes, various types of information to the image processing apparatuses 30, the user terminals 50, and the outside. The management server 10 is capable of obtaining, for execution of various processes, various types of information which are transmitted from the image processing apparatuses 30, the user terminals 50, and the outside.

For example, the management server 10 obtains conversation data between a user and a conversation partner, and extracts the user's intention from the obtained conversation data. In the present exemplary embodiment, a “conversation partner” refers to an image processing apparatus 30 or a user terminal 50; “conversation data” refers to information which may be input/output to/from an image processing apparatus 30 or a user terminal 50, and is, for example, voice information or text information. A user's intention extracted by the management server 10 includes the user's intention about a print setting of an image processing apparatus 30. A “user's intention about a print setting” includes, for example, information about why the user wants such a print setting, and information about for whom and how the user wants to use printed matter.

The management server 10 is capable of proposing, to a user, information about change of a print setting of an image processing apparatus 30 and the range of application of the print setting, which are inferred from the user's extracted intention. The management server 10 is capable of inferring, for proposal to a user, description about change of a print setting satisfying the user's intention, as the information about change of a print setting of an image processing apparatus 30. Hereinafter, a combination of the information about change of a print setting of an image processing apparatus 30 and the range of application of the print setting, which are inferred from a user's intention by the management server 10, may be called “profile information”.

The management server 10 is capable of inferring multiple descriptions about changes of print settings satisfying a user's intention, and proposing the changes to the user with use of user-selectable options. “To propose changes to a user with use of user-selectable options” refers to, for example, display of options, as text information, on a screen of an image processing apparatus 30 or a user terminal 50, or output of options, as voice information, from an image processing apparatus 30 or a user terminal 50.

In extraction of a user's intention from conversation data between the user and a conversation partner, the management server 10 may use a machine learning model (hereinafter called the “present model”) which extracts, for output, predetermined types of information from input conversation data between the user and the conversation partner. The present model may be, for example, a natural language understanding (NLU) model which is capable of extracting DATE (date), PRODUCT (print usage), QUALITY (print quality), and the like as the “predetermined types of information”.

According to the present model, for example, when conversation data contains a user's utterance of “I want to print, with high quality, presentation material used next weekend for an operation meeting,” the following information is extracted as the “predetermined types of information”: “next weekend”, as DATE (date); “for an operation meeting”, as PRODUCT (print usage); “high quality”, as QUALITY (print quality).

The management server 10 is capable of extracting a user's intention from conversation data between the user and a conversation partner which is made after change of a print setting based on the “information about change of a print setting” which has been proposed to the user. In this case, the management server 10 may train the present model on an association between the user's satisfaction degree, which is inferred from the user's extracted intention, on the changed print setting and a history record of the change of the print setting.

The management server 10 may exclude, from training targets of the present model, a history record of change of a print setting for which a user's inferred satisfaction degree on the changed print setting does not reach a predetermined reference. In this case, a history record of change of a print setting, for which a user's satisfaction degree does not reach the predetermined reference, may include a history record of change of the range of application of the print setting.

The management server 10 is capable of extracting each user's intention from conversation data between the user and their conversation partner. In this case, the management server 10 may train the present model on an association between each user's satisfaction degree, which is inferred from the user's extracted intention, on changed print setting and a history record of change of the print setting for which the user's satisfaction degree does not reach the predetermined reference. Each “user” refers, for example, to a participant who attends the same meeting.

The management server 10 is capable of extracting a user's intention from conversation data between the user and a conversation partner by using syntaxes predefined for identifying at least a part corresponding to the user's intention. In this case, the management server 10 may extract description about change of a print setting and the range of application of the changed print setting from conversation data between a user and a conversation partner by using syntaxes predefined for further identifying a part corresponding to description about change of a print setting and a part corresponding to the range of application of the changed print setting. The configuration and processes of the management server 10 will be described below in detail.

### Image Processing Apparatuses 30

The image processing apparatuses 30 perform various processes in accordance with input operations of users who use the image processing system 1. For example, the image processing apparatuses 30 are capable of performing, for example, a print process of forming, for output, an image on a sheet or the like as a recording medium, a copy process of copying, for output, a document image onto a sheet or the like, a reading process of reading an image formed on a sheet or the like, and a process of transmitting a document by facsimile. The image processing apparatuses 30 may be, for example, multifunction devices of so-called electrophotographic systems which form toner images on print surfaces of sheets, or printers of so-called inkjet systems which eject ink on print surfaces of sheets.

The image processing apparatuses 30 display a user interface, receive input operations on the user interface, and obtain the input information. The input operations on a user interface may be classified into direct operation or remote operation. The direct operation refers to a direct input operation, on a user interface displayed on an image processing apparatus 30, performed by a user who is in front of the image processing apparatus 30. The remote operation refers to an indirect input operation, on a user interface displayed on a user terminal 50, performed by a user who operates the user terminal 50 serving as a remote terminal connected to an image processing apparatus 30 over the network 90.

The image processing apparatuses 30 are capable of obtaining, for execution of various processes, various types of information transmitted from the management server 10, the user terminals 50, and the outside. The image processing apparatuses 30 are capable of transmitting various types of information to the management server 10, the user terminals 50, and the outside. For example, the image processing apparatuses 30 have conversations with users by obtaining input voice/text information, and outputting corresponding voice/text information.

The image processing apparatuses 30 receive, from the user terminals 50, instructions to perform jobs, and do the jobs. A “job” refers to a unit indicating a predetermined process performed by an image processing apparatus 30. The “predetermined process” refers, for example, to a print process of forming, for output, an image on a medium such as a sheet, a copy process of copying, for output, a document image on a medium such as a sheet, a reading process of reading an image formed on a sheet or the like, and a process of transmitting a document by facsimile. The image processing apparatuses 30 are capable of transmitting various types of information to the user terminals 50. The configuration and processes of an image processing apparatus 30 will be described in detail below.

### User Terminals 50

The user terminals 50 are information processing apparatuses, such as smartphones, tablet terminals, and personal computers, which are operated by users who use the image processing system 1. In the user terminals 50, application software, which enables the image processing apparatuses 30 to be remotely operated, is installed. The user terminals 50 are capable of obtaining, for execution of various processes, various types of information transmitted from the management server 10, the image processing apparatuses 30, and the outside. The user terminals 50 are capable of transmitting various types of information to the management server 10, the image processing apparatuses 30, and the outside.

For example, the user terminals 50 have conversations with users by obtaining input voice/text information and outputting corresponding voice/text information. The user terminals 50 transmit, to the image processing apparatuses 30, information, such as instructions to change print settings and instructions to do jobs. The configuration and processes of a user terminal 50 will be described below in detail.

The configuration of the image processing system 1 is exemplary. As long as the image processing system 1, as a whole, has a function of implementing the above-described processes, the image processing system 1 may have any configuration. Therefore, among functions for implementing the above-described processes, some or all may be shared in the image processing system 1, or may be performed in cooperation. For example, some or all of the functions of the management server 10 included in the image processing system 1 may be performed as functions of another information processing apparatus; some or all of the functions of another information processing apparatus may be performed as functions of the management server 10. Further, some or all of the functions of the management server 10 and other apparatuses included in the image processing system 1 may be transferred to another server or the like (not illustrated). Thus, functions as the entire image processing system 1 may be promoted. In addition, processes may be complemented to one another.

### Hardware Configuration

### Hardware Configuration of Management Server 10

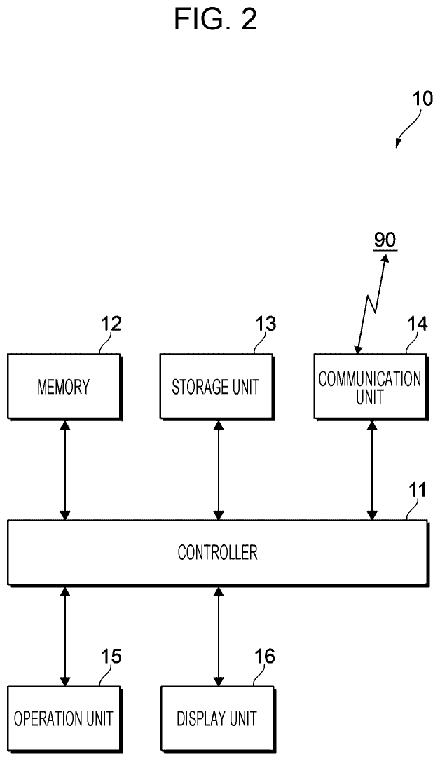

FIG. 2 is a diagram illustrating an exemplary hardware configuration of the management server 10 to which the present exemplary embodiment is applied.

The management server 10 includes a controller 11, a memory 12, a storage unit 13, a communication unit 14, an operation unit 15, and a display unit 16. These units are connected to each other, for example, through a data bus, an address bus, or a peripheral component interconnect (PCI) bus.

The controller 11 is a processor which controls functions of the management server 10 through execution of various types of software, such as basic software (OS) and application software. In the present exemplary embodiment, the processes are performed by any computer. The computer may perform the processes by using a processor serving as hardware, a program serving as software, or combination of these. In this case, the processor is configured to perform the processes in the exemplary embodiment in cooperation with the program and may function as a unit or a means in the exemplary embodiment. The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU).

Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage). The program may be stored in such a divided manner in multiple non-transitory computer readable media present in apparatuses physically away from each other.

The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content.

The memory 12, which is a storage area for storage of various types of software and data or the like used in execution of the software, is used as a work area in computation. The memory 12 is formed, for example, of a random access memory (RAM).

The storage unit 13 is a storage area for storage of input data for various types of software, output data from various types of software, and the like. The storage unit 13 is formed, for example, of a hard disk drive (HDD), a solid state drive (SSD), and a semiconductor memory which are used in storage of programs, various types of setting data, and the like. The storage unit 13 includes a database storing various types of information.

The communication unit 14 receives/transmits data from/to the image processing apparatuses 30, the user terminals 50, and the outside over the network 90. The operation unit 15, which is formed, for example, of a keyboard, a mouse, mechanical buttons, and switches, receives input operations.

The operation unit 15 includes a touch sensor forming a touch panel integrally with the display unit 16.

The display unit 16, which is formed, for example, of a liquid-crystal display or an organic light-emitting diode (OLED) display used in display of information, displays image data, text data, and the like. The display unit 16 displays a user interface or the like.

### Hardware Configuration of Image Processing Apparatus 30

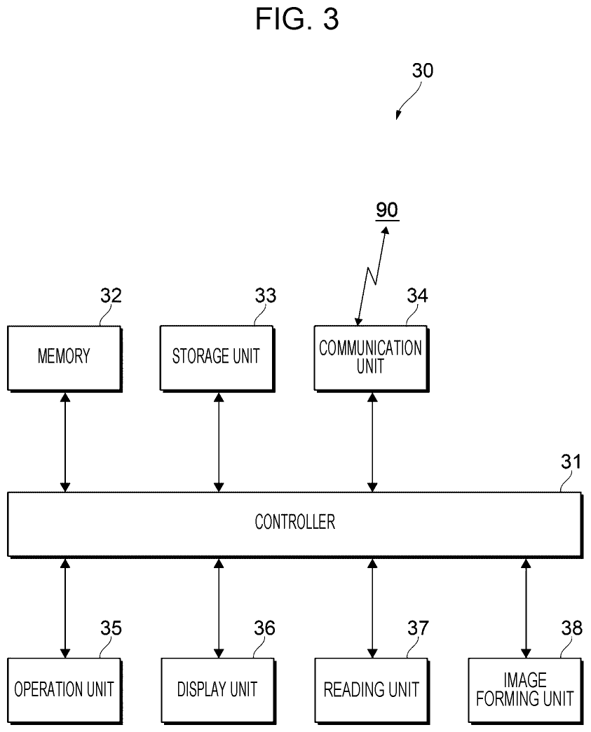

FIG. 3 is a diagram illustrating an exemplary hardware configuration of an image processing apparatus 30 to which the present exemplary embodiment is applied.

The image processing apparatus 30 includes a controller 31, a memory 32, a storage unit 33, a communication unit 34, an operation unit 35, and a display unit 36 which correspond to the controller 11, the memory 12, the storage unit 13, the communication unit 14, the operation unit 15, and the display unit 16, respectively, in FIG. 2. In addition to these configurations, the image processing apparatus 30 includes a reading unit 37 and an image forming unit 38. These units are connected, for example, through a data bus, an address bus, or a PCI bus.

The reading unit 37 reads an image recorded on a medium such as a sheet. The reading unit 37 may be formed, for example, of a charge coupled device (CCD) scanner which reduces, through a lens, reflected light for light emitted onto a document from a light source and which receives the reduced light by CCDs. The reading unit 37 may be formed, for example, of a contact image sensor (CIS) scanner which receives, by a CIS, reflected light for light emitted sequentially onto a document from a light-emitting diode (LED) light source. The reading unit 37 is capable of reading, through a camera, information of an image (for example, a QR code®) displayed on the display unit 36.

The image forming unit 38 forms an image, which is to be printed, on a print surface of a sheet serving as a recording medium, for example, by using an electrophotographic system or an inkjet system.

### Hardware Configuration of User Terminal 50

A user terminal 50 includes a controller, a memory, a storage unit, a communication unit, an operation unit, and a display unit which correspond to the controller 11, the memory 12, the storage unit 13, the communication unit 14, the operation unit 15, and the display unit 16, respectively, in FIG. 2.

### Functional Configuration of Management Server 10

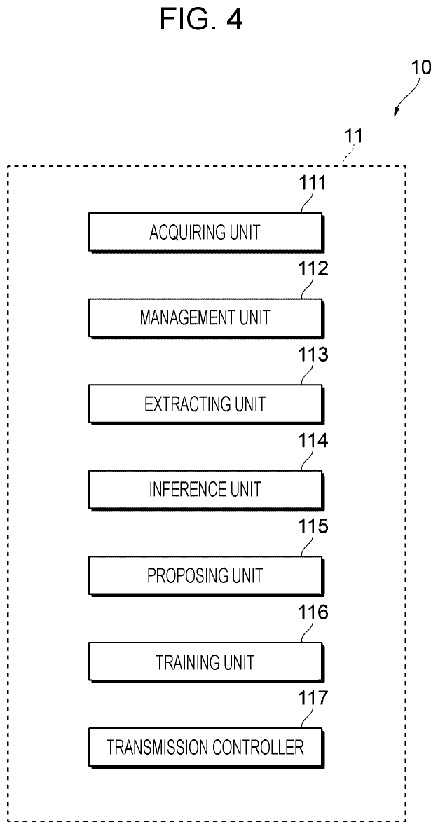

FIG. 4 is a diagram illustrating an exemplary functional configuration of the controller 11 of the management server 10.

The controller 11 of the management server 10 functions as an acquiring unit 111, a management unit 112, an extracting unit 113, an inference unit 114, a proposing unit 115, a training unit 116, and a transmission controller 117.

The acquiring unit 111 acquires various types of information. For example, the acquiring unit 111 acquires conversation data between a user and a conversation partner. The conversation data between a user and a conversation partner is information transmitted from an image processing apparatus 30 or a user terminal 50, which is the user's conversation partner, to the management server 10.

The management unit 112 stores, for management, various types of information in the database in the storage unit 13 (see FIG. 2). For example, the management unit 112 stores, for management, information about users in the database. The information about users may include information with which the users are uniquely identifiable, information with which the user terminals 50 used by the users are uniquely identifiable, and information with which the image processing apparatuses 30 used by the users are uniquely identifiable. Further, the information about users may include a history record of the users' intentions extracted by the extracting unit 113 described below, and information about change of a print setting which is inferred by the inference unit described below.

The management unit 112 stores, for management, information about each of the image processing apparatuses 30-1 to 30-n in the database. The information about each of the image processing apparatuses 30-1 to 30-n may include information with which each of the image processing apparatuses 30-1 to 30-n is uniquely identifiable, and information about the performance, location, and the like of each of the image processing apparatuses 30-1 to 30-n. The management unit 112 stores, for management, information about each of the user terminals 50-1 to 50-m in the database. The information about each of the user terminals 50-1 to 50-m may include information with which each of the user terminals 50-1 to 50-m is uniquely identifiable, and information about the performance, print settings, location, and the like of each of the user terminals 50-1 to 50-m.

The management unit 112 stores, for management, conversation data, which is acquired by the acquiring unit 111, in the database. The management unit 112 stores, for management, a combination of information about change of a print setting, which is inferred by the inference unit described below, and the range of application of the print setting, as profile information in the database. The profile information may be managed so as to be optionally linked to information about users, information about the image processing apparatuses 30, and information about the user terminals 50.

The extracting unit 113 extracts a user's intention from conversation data between the user and a conversation partner. A user's intention extracted by the extracting unit 113 includes the user's intention about a print setting of an image processing apparatus 30. The “print setting” encompasses, for example, scale-up/scale-down, line spacing, image quality, print-sheet quality, summary, folding, printer, pages to be printed, single-sided/double-sided, collation (by copy, by page), print direction (portrait/landscape), size, margin, and the number of pages per sheet. The “print setting” encompasses, for example, 1UP (printing one page on a single sheet)/2UP (printing two pages on a single sheet)/ . . . , monochrome/color, color/density, sheet type, feed method, and presence of preview display. A “user's intention about a print setting” refers, for example, to having bad eyes, ecology-oriented, image-quality-oriented, time-performance-oriented, usage for meeting/presentation, and specific folding.

In extraction of a user's intention from conversation data between the user and a conversation partner, the extracting unit 113 is capable of using the present model which enables predetermined types of information to be extracted, for output, from the input conversation data between the user and the conversation partner. The present model is trained by the training unit 116 described below.

The extracting unit 113 is capable of extracting a user's intention from conversation data between the user and a conversation partner by using predefined syntaxes. Further, to identify a part corresponding to change of a print setting and a part corresponding to the range of application of the changed print setting, the extracting unit 113 is capable of extracting the description about change of the print setting and the range of application of the changed print setting by using predefined syntaxes.

In this case, for example, a syntax, “Since XX, I want to YY”, may be defined in advance. A part corresponding to “XX” may be extracted as a user's intention, and a part corresponding to “YY” may be extracted as description about change of a print setting. A syntax, “For ZZ, I want to YY”, may be defined in advance. A part corresponding to “ZZ” may be extracted as the range of application of the print setting.

The inference unit 114 infers information about change of a print setting of an image processing apparatus 30 on the basis of a user's intention extracted by the extracting unit 113. Specifically, the inference unit 114 infers description about change of a print setting satisfying a user's intention, as the information about change of a print setting of an image processing apparatus 30. The inference unit 114 is capable of inferring multiple descriptions about changes of print settings satisfying a user's intention.

The “information about change of a print setting” refers, for example, to scale-up, 1UP, larger line spacing, 2UP, image-quality parameter, addition of a summary, print quality, and Z folding and cutting. The “description about change of a print setting satisfying a user's intention” refers, for example, to scaled-up displaying for a user having bad eyes, a reduction of the number of print sheets for an ecology-oriented user (such as 2UP or double-sided).

The inference unit 114 infers a user's satisfaction degree for a changed print setting on the basis of the user's intention extracted by the extracting unit 113 after change of the print setting. A user's satisfaction degree for a changed print setting, which is inferred by the inference unit 114, is used as training data in training the present model by the training unit 116 described below.

The proposing unit 115 proposes, to a user, information about change of a print setting which is inferred by the inference unit 114. Specifically, the proposing unit 115 exerts control for outputting, to a user, information about inferred change of a print setting, as voice information or text information. The proposing unit 115 is capable of proposing, to a user, the range of application of the changed print setting, as the information about change of a print setting.

The range of application of a changed print setting refers, for example, to a range of application in the unit of a user, the unit of an organization to which the user belongs, or the unit of an image processing apparatus 30 usable by the user. Among these, the unit of a user and the unit of an organization to which the user belongs are ranges of application based on the user' properties. The unit of an image processing apparatus 30 usable by the user is a range of application based on the performance and location of the image processing apparatus 30. In this case, the performance of an image processing apparatus 30 refers, for example, to printable sheet type or sheet folding. The location of an image processing apparatus 30 refers, for example, to a meeting room, an office, or a convenience store.

The training unit 116 trains the present model. For example, the training unit 116 trains the present model on an association between a user's satisfaction degree for a changed print setting, which is inferred from the user's extracted intention, and a history record of change of the print setting. In this case, the training unit 116 may exclude, from training targets, a history record of change of a print setting for which the user's satisfaction degree for the changed print setting does not reach the predetermined reference.

The training unit 116 is capable of training the present model on the ranges of application of print settings which are inferred from users' extracted intentions. For example, when a general intention which is applicable to any user is found, training may be performed so that the range of application for such an intention is inferred as being “general”. In this case, a “general intention” refers, for example, to an intention related to appearance of printed matter or an intention of distribution of printed matter to unspecific users.

When an intention applicable only to a specific user or group is found, training may be performed so that the range of application for such an intention is inferred as being a specific user or group. In this case, an “intention applicable only to a specific user or group” refers, for example, to the case in which a limited expression, such as “for myself” or “for A Corp”, is used in a conversation. When an intention applicable only to a specific place or a specific image processing apparatus 30 is found, training may be performed so that the range of application for such an intention is inferred as being the specific place or the image processing apparatus 30. In this case, an “intention applicable only to a specific place or a specific image processing apparatus 30” refers, for example, to the case in which a print setting used in a specific place is used in a conversation.

The transmission controller 117 exerts control for transmitting various types of information through the communication unit 14 (see FIG. 2). For example, the transmission controller 117 exerts control for transmitting various types of information to the image processing apparatuses 30 or the user terminals 50. Examples of information transmitted to the image processing apparatuses 30 include control information for causing the image processing apparatuses 30 to perform various processes. Examples of information transmitted to the user terminals 50 include information about change of print settings which is inferred by the inference unit 114.

### Process Flow of Management Server 10

### Before Change of Print Settings

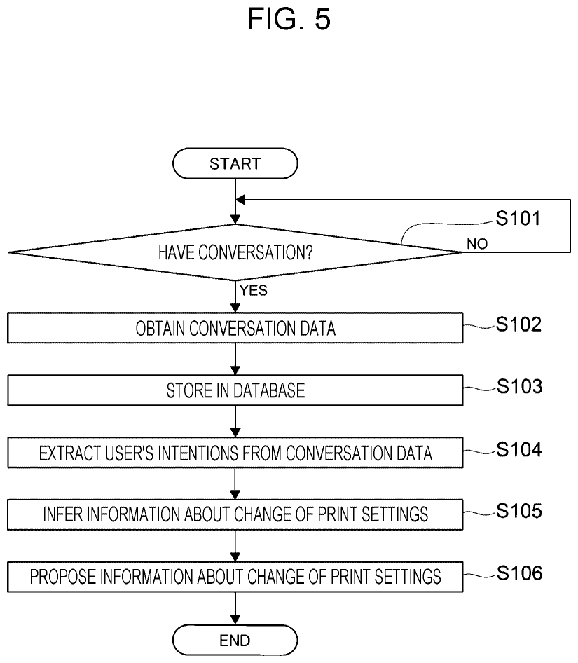

FIG. 5 is a flowchart of an exemplary process before change of print settings, among the processes of the management server 10.
If a user and a conversation partner have a conversation (YES in step S101), the management server 10 obtains the conversation data (step S102), and stores it in the database in the storage unit 13 (see FIG. 2) (step S103). Then, the management server 10 proceeds to the process in step S104. In contrast, if a user and a conversation partner do not have a conversation (NO in step S101), the management server 10 repeatedly performs the determination process in step S101.

The management server 10 extracts the user's intentions from the conversation data obtained in step S102 (step S104), and infers information about change of print settings of an image processing apparatus 30 on the basis of the user's extracted intentions (step S105). Then, the management server 10 proposes, to the user, the information about change of print settings which is inferred in step S105 (step S106). Thus, the management server 10 ends the process performed before change of print settings (END).

### After Change of Print Settings

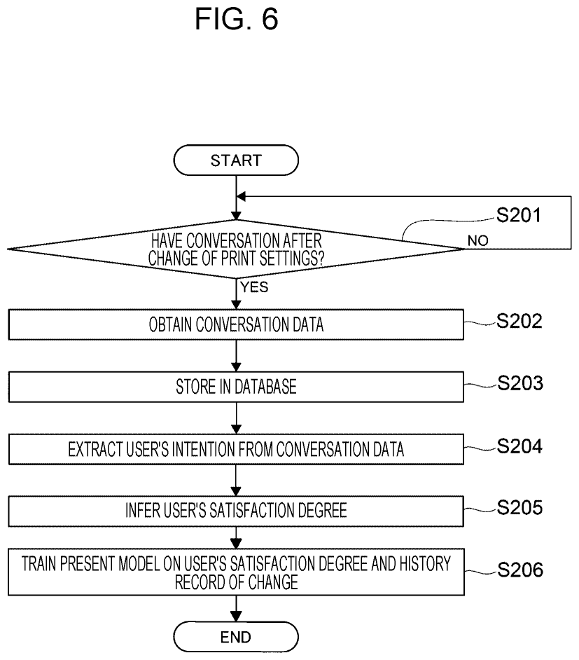

FIG. 6 is a flowchart of an exemplary process after change of print settings, among the processes of the management server 10.

If the user and the conversation partner have a conversation after the change of print settings (YES in step S201), the management server 10 obtains the conversation data (step S202), and stores it in the database in the storage unit 13 (see FIG. 2) (step S203). Then, the management server 10 proceeds to the process in step S204. In contrast, if the user and the conversation partner do not have a conversation after the change of print settings (NO in step S201), the management server 10 repeatedly performs the determination process in step S201.

The management server 10 extracts the user's intention from the conversation data obtained in step S202 (step S204), and infers the user's satisfaction degree for the changed print settings on the basis of the user's extracted intention (step S205). Then, the management server 10 trains the present model on the user's satisfaction degree and a history record of the change (step S206). Thus, the management server 10 ends the process after the change of print settings (end).

### Concrete Examples

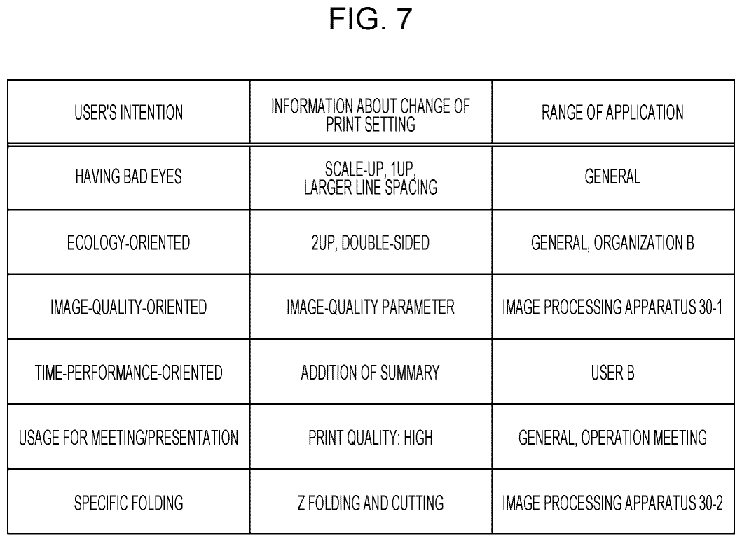

FIG. 7 is a diagram illustrating a concrete example of profile information.
FIG. 7 illustrates a concrete example of combinations among users' intentions extracted from conversation data between the users and their conversation partners, information about change of print settings which is inferred from the users' intentions, and the ranges of application of the print settings.

As illustrated in FIG. 7, for example, when a user's intention of “having bad eyes” is extracted, change of print settings for “scale-up”, “1UP”, and “larger line spacing” is proposed as the information about change of a print setting. In addition, it is proposed that the range of application of the change be “general” (applied to all registered users). In addition, for example, when a user's intention of “ecology-oriented” (placing more importance on ecology) is extracted, change of print settings for “2UP” and “double-sided” is proposed as the information about change of a print setting. In addition, it is proposed that the range of application be “general” or “Organization B” (applied to the users belonging to Organization B).

For example, when a user's intention of “image-quality-oriented” is extracted, change of a print setting for “image-quality parameter” is proposed as the information about change of a print setting. In addition, it is proposed that the range of application be “image processing apparatus 30-1” (applied to the users using the image processing apparatus 30-1). For example, when a user's intention of “time-performance-oriented” (placing importance on time performance) is extracted, change of a print setting for “addition of summary” is proposed as the information about change of a print setting. In addition, it is proposed that the range of application be “User B”.

For example, a user's intention of “usage for meeting/presentation” (printing as material for meeting/presentation) is extracted, change of a print setting for “print quality: high” (higher print quality) is proposed as the information about change of a print setting. In addition, it is proposed that the range of application be “general” or “operation meeting” (applied to the users belonging to an operation meeting). For example, when a user's intention of “specific folding” is extracted, change of a print setting for “Z folding and cutting” is proposed as the information about change of a print setting. In addition, it is proposed that the range of application be “image processing apparatus 30-2” (applied to the users using the image processing apparatus 30-2).

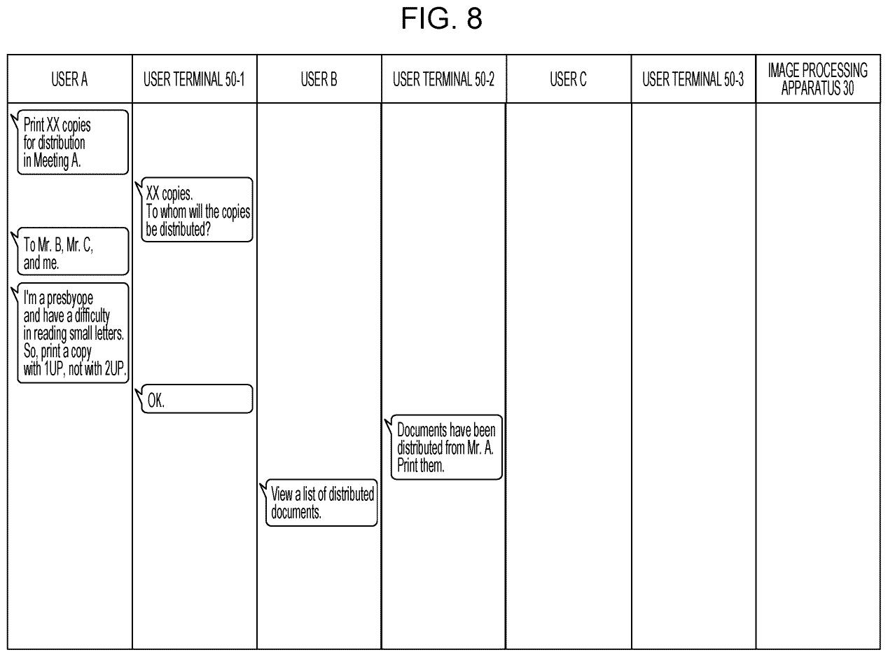

FIGS. 8 to 13 are diagrams illustrating concrete examples of conversation data between users and conversation partners.
FIGS. 8 to 13 illustrate conversation data of User A whose conversation partners are the user terminal 50-1 and an image processing apparatus 30, User B whose conversation partners are the user terminal 50-2 and the image processing apparatus 30, and User C whose conversation partners are the user terminal 50-3 and the image processing apparatus 30.

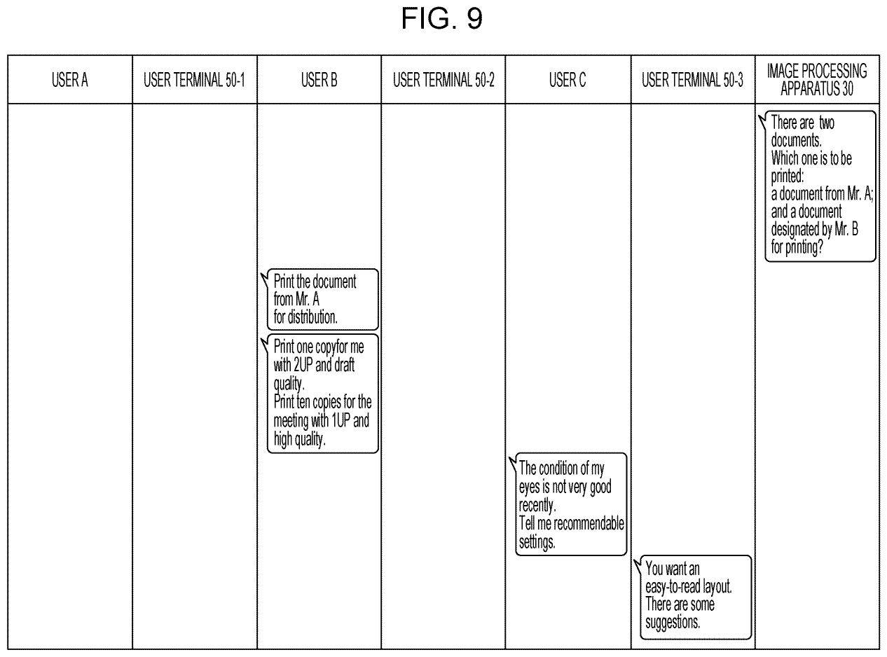

FIGS. 8 and 9 illustrate concrete examples of conversation data until the image processing apparatus 30 is made to perform a print process. The conversation data illustrated in FIG. 8 includes User A's utterance of “Print XX copies for distribution in Meeting A,” and the user terminal 50-1's utterance of “XX copies. To whom will the copies be distributed?” In addition, the conversation data includes User A's utterances of “To Mr. B, Mr. C, and me.” and “I'm a presbyope and have a difficulty in reading small letters. So, print a copy with 1UP, not with 2UP,” and the user terminal 50-1's utterance of “OK.” In addition, the conversation data includes the user terminal 50-2's utterance of “Documents have been distributed from Mr. A. Print them,” and User B's utterance of “View a list of distributed documents.”

The conversation data illustrated in FIG. 9 includes the image processing apparatus 30's utterance of “There are two documents. Which one is to be printed: a document from Mr. A; and a document designated by Mr. B for printing?” and User B's utterance of “Print the document from Mr. A for distribution.” In addition, the conversation data includes User B's utterance of “Print one copy for me with 2UP and draft quality. Print ten copies for the meeting with 1UP and high quality.” In addition, the conversation data includes User C's utterance of “The condition of my eyes is not very good recently. Tell me recommendable settings,” and the user terminal 50-3's utterance of “You want an easy-to-read layout. There are some suggestions.”

The management server 10 (See FIG. 1) extracts users' intentions from the conversation data illustrated in FIGS. 8 and 9. On the basis of the extracted users' intentions, the management server 10 infers description about changes of print settings satisfying the users' intentions, and proposes, to each of Users A to C, the corresponding description about inferred changes of print settings.

For example, from User A's utterance of “I'm a presbyope and have a difficulty in reading small letters. So, print a copy with 1UP, not with 2UP.” in the conversation data illustrated in FIG. 8, the management server 10 extracts User A's intention of “prefer large characters because of being a presbyope”. In this case, the management server 10 is capable of managing, as the profile information, data indicating that a print setting is to be changed from “2UP” to “1UP” and data indicating that the range of application of the change is “only for User A”, and is capable of proposing the data to User A.

For example, from User B's utterance of “Print one copy for me with 2UP and draft quality. Print ten copies for the meeting with 1UP and high quality.” in the conversation data illustrated in FIG. 9, the management server 10 extracts User B's intention of “User B themselves does not care about print quality” and User B's intention of “User B cares about print quality for distribution material for meetings”. In this case, the management server 10 is capable of managing, as the profile information, data indicating that print settings are to be set to “2UP” and “quality: draft” and data indicating that the range of application of the setting is “only for User B”, and is capable of proposing the data to User B. In addition, the management server 10 is capable of managing, as the profile information, data indicating that print settings are to be set to “1UP” and “quality: high” and data indicating that the range of application of the setting is “meeting attendant”, and is capable of proposing the data to User B.

For example, from User C's utterance of “The condition of my eyes is not very good recently. Tell me recommendable settings.” in the conversation data illustrated in FIG. 9, the management server 10 extracts User C's intention of “bad eyes”. In this case, the management server 10 is capable of presenting options as the information about change of a print setting. As options, for example, four options of “Change to an easy-to-read font; Widen character spacing and line spacing in a page layout; More figures; View an electronic document so as to be easy to read through scale-up” may be presented.

Each of Users A to C, who receives proposal of description about change of a print setting satisfying the user's intention, changes the print setting according to the proposed data, and causes the image processing apparatus 30 to perform a print process. Then, a conversation, as described below, is made after the printing.

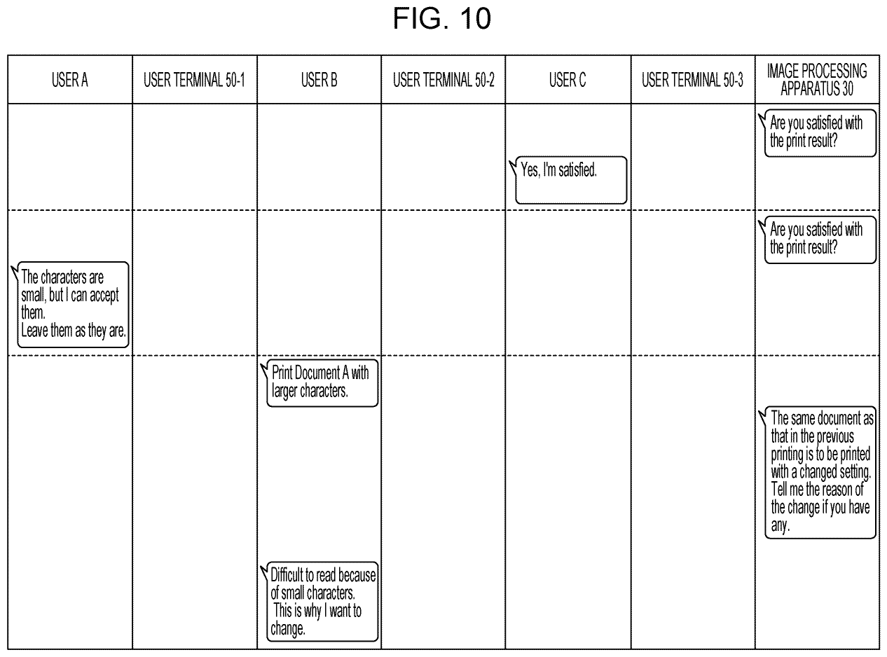

FIG. 10 illustrates three concrete examples of conversation data after the image processing apparatus 30 performs print processes. The first example (upper row) of the concrete examples of conversation data illustrated in FIG. 10 includes the image processing apparatus 30's utterance of “Are you satisfied with the print result?” and User C's utterance of “Yes, I'm satisfied.” The second example (middle row) of the concrete examples of the conversation data illustrated in FIG. 10 includes the image processing apparatus 30′ utterance of “Are you satisfied with the print result?” and User A's utterance of “The characters are small, but I can accept them. Leave them as they are.” That is, the first example (upper row) and the second example (middle row) of the concrete examples of the conversation data illustrated in FIG. 10 are concrete examples illustrating the case in which the image processing apparatus 30's utterance for confirming a print result is made to a user after a print process by the image processing apparatus 30.

The third example (lower row) of the concrete examples of the conversation data illustrated in FIG. 10 includes User B's utterance of “Print Document A with larger characters,” the image processing apparatus 30 utterance of “The same document as that in the previous printing is to be printed with a changed setting. Tell me the reason of the change if you have any,” and User B's utterance of “Difficult to read because of small characters. This is why I want to change.” That is, the third example (lower row) of the concrete examples of the conversation data illustrated in FIG. 10 is a concrete example illustrating the case in which the user's utterance to instruct the image processing apparatus 30 to change a print setting on the basis of a print result is made after a print process by the image processing apparatus 30.

As described above, the management server 10 may exclude, from training targets for the present model, a history record of change of a print setting, for which a user's inferred satisfaction degree on a changed print setting does not reach the predetermined reference. Therefore, for example, the first example (upper row) of the three concrete examples illustrated in FIG. 10 may be handled as a training target for the present model because the user's satisfaction degree in the example is regarded as reaching the predetermined reference. In contrast, the second example (middle row) and the third example (lower row) of the three concrete examples illustrated in FIG. 10 may be excluded from the training targets for the present model because the users' satisfaction degrees of the examples are not regarded as reaching the predetermined reference.

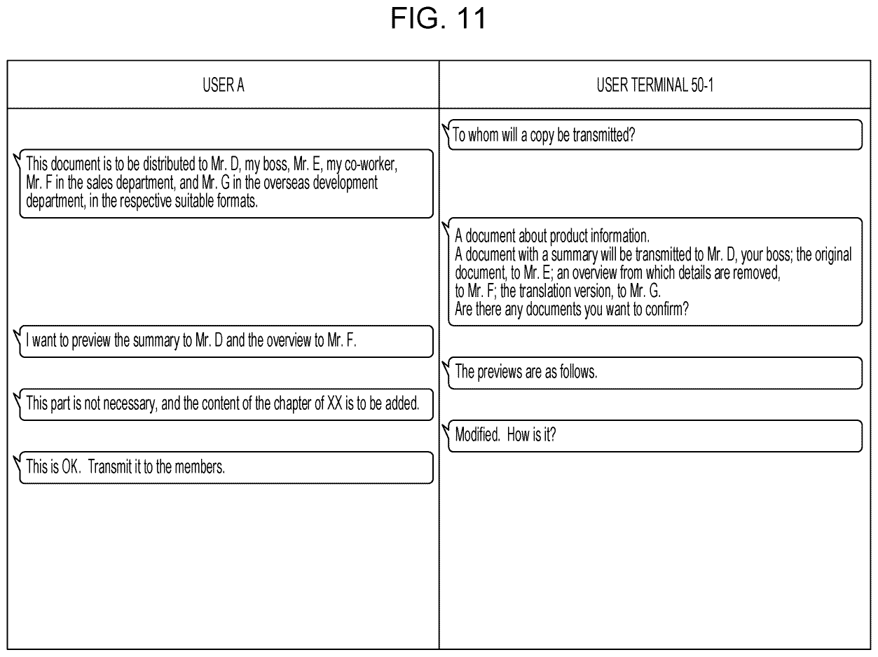

FIG. 11 illustrates a concrete example of conversation data made when a user provides an instruction to transmit a print-target document to other users. The conversation data illustrated in FIG. 11 includes the user terminal 50-1 utterance of “To whom will a copy be transmitted?” and User A's utterance of “This document is to be distributed to Mr. D, my boss, Mr. E, my co-worker, Mr. F in the sales department, and Mr. G in the overseas development department, in the respective suitable formats.” In addition, the conversation data includes the user terminal 50-1′ utterance of “A document about product information. A document with a summary will be transmitted to Mr. D, your boss; the original document, to Mr. E; an overview from which details are removed, to Mr. F; the translation version, to Mr. G. Are there any documents you want to confirm?”

In addition, the conversation data includes User A's utterance of “I want to preview the summary to Mr. D and the overview to Mr. F,” the user terminal 50-1's utterance of “The previews are as follows,” and User A's utterance of “This part is not necessary, and the content of the chapter of XX is to be added.” In addition, the conversation data includes the user terminal 50-1's utterance of “Modified. How is it?” and User A's utterance of “This is OK. Transmit it to the members.”

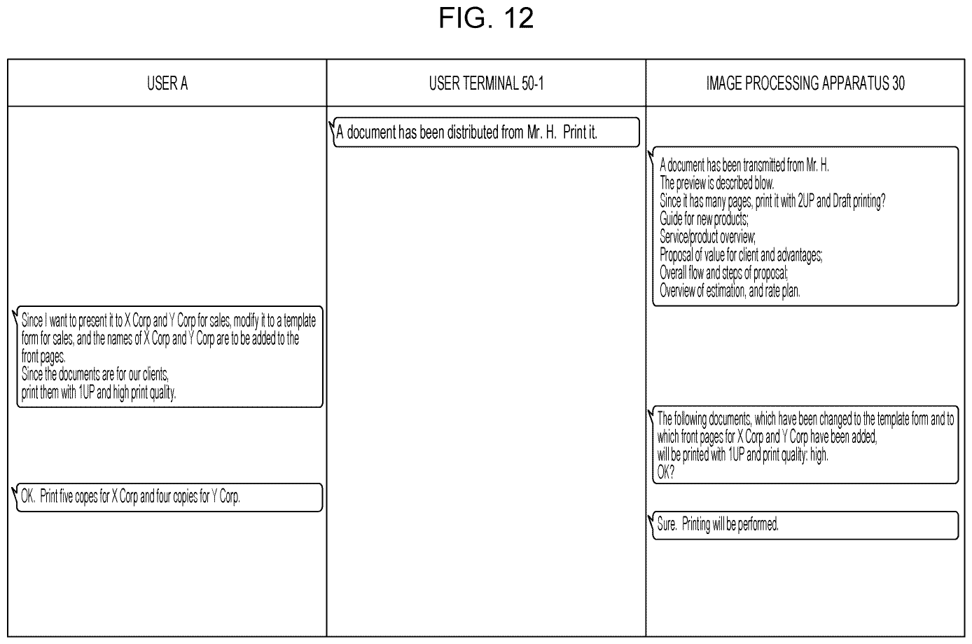

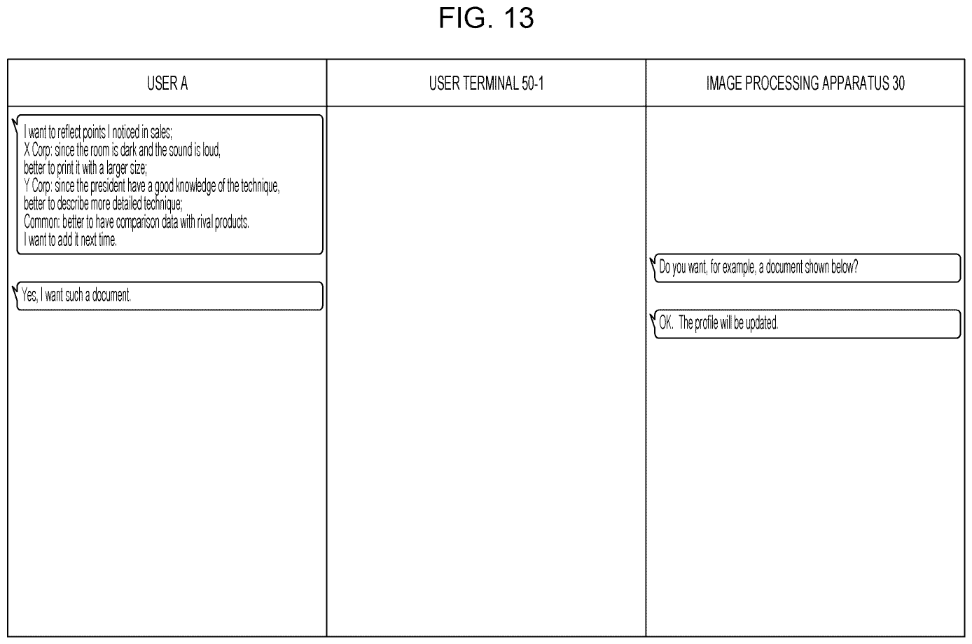

FIGS. 12 and 13 illustrate concrete examples of conversation data made when a user provides an instruction to print a document distributed from another user. The conversation data illustrated in FIG. 12 includes the user terminal 50-1's utterance of “A document has been distributed from Mr. H. Print it.” In addition, the conversation data includes the image processing apparatus 30's utterance of “A document has been transmitted from Mr. H. The preview is described blow. Since it has many pages, print it with 2UP and Draft printing? Guide for new products; Service/product overview; Proposal of value for client and advantages; Overall flow and steps of proposal; Overview of estimation, and rate plan.”

In addition, the conversation data includes User A's utterance of “Since I want to present it to X Corp and Y Corp for sales, modify it to a template form for sales, and the names of X Corp and Y Corp are to be added to the front pages. Since the documents are for our clients, print them with 1UP and high print quality.” In addition, the conversation data includes the image processing apparatus 30's utterance of “The following documents, which have been changed to the template form and to which front pages for X Corp and Y Corp have been added, will be printed with 1UP and print quality: high. OK?” In addition, the conversation data includes User A's utterance of “OK. Print five copes for X Corp and four copies for Y Corp,” and the image processing apparatus 30's utterance of “Sure. Printing will be performed.”

The conversation data illustrated in FIG. 13 includes User A's utterance of “I want to reflect points I noticed in sales; X Corp: since the room is dark and the sound is loud, better to print it with a larger size; Y Corp: since the president have a good knowledge of the technique, better to describe more detailed technique; Common: better to have comparison data with rival products. I want to add it next time.” In addition, the conversation data includes the image processing apparatus 30's utterance of “Do you want, for example, a document described below?” User A's utterance of “Yes, I want such a document,” and the image processing apparatus 30's utterance of “OK. The profile will be updated.”

In printing a document distributed from a user to another user, a predetermined identifier which enables job matching is added to the document. Such an identifier is, for example, a QR code® associated with a job. Use of such an identifier enables, for example, proposal of a print setting desirable, not only for a user who has printed the document for distribution, but also for persons who have received distribution of the document, for example, in a meeting. In this case, when a location of use, such as a meeting room, is identified, feedback is requested from the persons who have gathered in the identified location of use.

The feedback refers to impressions about the distributed document which are transmitted through input on an information processing terminal such as a smartphone. Persons, who have gathered in an identified location, use their information processing terminals such as smartphones, which are used by the persons, to read a QR code® on the distributed document. Thus, a user interface for inputting impressions about the distributed document is displayed. From the fed-back information, the present model is used to extract intentions of the persons who have transmitted the feedback. The management server 10 infers information about change of print settings and infers the ranges of application of the print settings. This enables documents, which are printed in accordance with descriptions about the feedback, to be distributed to the persons, who have done the feedback, for example, in the next meeting.

### Other Embodiments

The present exemplary embodiment is described above. However, the present disclosure is not limited to the exemplary embodiment described above. The effect of the present disclosure is not limited to that described in the above exemplary embodiment. For example, each of the overall configuration of the image processing system 1 illustrated in FIG. 1, the hardware configuration of the management server 10 illustrated in FIG. 2, and the hardware configuration of each image processing apparatus 30 illustrated in FIG. 3 is merely exemplary to achieve the object of the present disclosure, and is not limited particularly.

The functional configuration of the management server 10 illustrated in FIG. 4 is also merely exemplary, and is not limited particularly. Any configuration may be employed as long as a function, which may perform, as a whole, the processes described above, is included in the image processing system 1 in FIG. 1. The functional configuration used to implement this function is not limited to the example in FIG. 4. The order of steps of the processes of the management server 10 which are illustrated in the flowcharts in FIGS. 5 and 6 is merely exemplary, and is not limited particularly. Other than processes performed in a time-series manner according to the order of illustrated steps, processes may be performed, not necessarily in a time series manner, but in parallel or individually. The concrete examples illustrated in FIGS. 7 to 13 are merely exemplary, and are not limited particularly.

The present disclosure may be applied also to programs and program products.
The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An image processing apparatus comprising:
a processor configured to:
   extract a user's intention about a print setting from conversation data between the user and a conversation partner; and
   propose, to the user, information about change of the print setting, the change being inferred from the extracted intention.
(((2)))

The image processing apparatus according to (((1))),
wherein the processor is configured to:
   propose, to the user, a range of application of the changed print setting, as the information about change of the print setting.
(((3)))

The image processing apparatus according to (((2))),
wherein the range of application is set based on a property of the user.
(((4)))

The image processing apparatus according to (((2))),
wherein the range of application is set based on performance or a location of the image processing apparatus.
(((5)))

The image processing apparatus according to (((2))),
wherein the processor is configured to:
   infer, for proposal to the user, description about change of the print setting satisfying the intention, as the information about change of the print setting.
(((6)))

The image processing apparatus according to (((5))),
wherein the processor is configured to:
   infer a plurality of descriptions about changes of the print settings satisfying the intention, for proposal to the user through options selectable by the user.
(((7)))

The image processing apparatus according to (((2))),
wherein the processor is configured to:
   extract the intention from the conversation data by using a machine learning model which, in response to reception of the conversation data, extracts, for output, a predetermined type of information from the conversation data.
(((8)))

The image processing apparatus according to (((7))),
wherein the processor is configured to:
   further extract the intention from the conversation data obtained after change of the print setting based on the proposed information about change; and
   train the machine learning model on an association between the user's satisfaction degree on the changed print setting and a history record of the change of the print setting, the satisfaction degree being inferred from the extracted intention.
(((9)))

The image processing apparatus according to (((8))),
wherein the processor is configured to:
   exclude, from training targets for the machine learning model, a history record of the change of the print setting for which the user's satisfaction degree does not reach a predetermined reference.
(((10)))

The image processing apparatus according to (((8))),
wherein the history record of the change of the print setting includes change of the range of application.
(((11)))

The image processing apparatus according to (((8))),
wherein the processor is configured to:
   for each of a plurality of the users,
   extract the intention from the user's conversation data; and
   train the machine learning model on an association between the user's satisfaction degree on the changed print setting and the history record of the change of the print setting, the satisfaction degree being inferred from the extracted intention.
(((12)))

The image processing apparatus according to any one of (((1))) to (((11))),
wherein the processor is configured to:
   extract the intention from the conversation data by using a predefined syntax for identifying at least a part corresponding to the intention.
(((13)))

The image processing apparatus according to (((12))),
wherein the processor is configured to:
   extract description about change of the print setting and a range of application from the conversation data by using the syntax predefined to further identify a part corresponding to the description about change and a part corresponding to the range of application of the changed print setting.
(((14)))

An image processing system comprising:
an image processing apparatus that performs printing based on a user operation, wherein the image processing apparatus includes a configuration included in the image processing apparatus according to any one of (((1))) to (((13))).
(((15)))

The image processing system according to (((14))),

wherein a conversation partner of the user is either one of the image processing apparatus and a remote terminal operated by the user.
(((16)))
A program causing a computer to execute a process, the computer controlling an image processing apparatus which performs printing based on an operation of a user, the process comprising:
   extracting the user's intention about a print setting from conversation data between the user and a conversation partner; and proposing, to the user, information about change of the print setting, the change being inferred from the extracted intention.

What is claimed is:

1. An image processing apparatus comprising:
a processor configured to:
extract a user's intention about a print setting from conversation data between the user and a conversation partner; and
propose, to the user, information about change of the print setting, the change being inferred from the extracted intention.

2. The image processing apparatus according to claim 1,
wherein the processor is configured to:
propose, to the user, a range of application of the changed print setting, as the information about change of the print setting.

3. The image processing apparatus according to claim 2,
wherein the range of application is set based on a property of the user.

4. The image processing apparatus according to claim 2,
wherein the range of application is set based on performance or a location of the image processing apparatus.

5. The image processing apparatus according to claim 2,
wherein the processor is configured to:
infer, for proposal to the user, description about change of the print setting satisfying the intention, as the information about change of the print setting.

6. The image processing apparatus according to claim 5,
wherein the processor is configured to:
infer a plurality of descriptions about changes of the print settings satisfying the intention, for proposal to the user through options selectable by the user.

7. The image processing apparatus according to claim 2,
wherein the processor is configured to:
extract the intention from the conversation data by using a machine learning model which, in response to reception of the conversation data, extracts, for output, a predetermined type of information from the conversation data.

8. The image processing apparatus according to claim 7,
wherein the processor is configured to:
further extract the intention from the conversation data obtained after change of the print setting based on the proposed information about change; and
train the machine learning model on an association between the user's satisfaction degree on the changed print setting and a history record of the change of the print setting, the satisfaction degree being inferred from the extracted intention.

9. The image processing apparatus according to claim 8,
wherein the processor is configured to:
exclude, from training targets for the machine learning model, a history record of the change of the print setting for which the user's satisfaction degree does not reach a predetermined reference.

10. The image processing apparatus according to claim 8,
wherein the history record of the change of the print setting includes change of the range of application.

11. The image processing apparatus according to claim 8,
wherein the processor is configured to:
for each of a plurality of the users,
extract the intention from the user's conversation data; and
train the machine learning model on an association between the user's satisfaction degree on the changed print setting and the history record of the change of the print setting, the satisfaction degree being inferred from the extracted intention.

12. The image processing apparatus according to claim 1,
wherein the processor is configured to:
extract the intention from the conversation data by using a predefined syntax for identifying at least a part corresponding to the intention.

13. The image processing apparatus according to claim 12,
wherein the processor is configured to:
extract description about change of the print setting and a range of application from the conversation data by using the syntax predefined to further identify a part corresponding to the description about change and a part corresponding to the range of application of the changed print setting.

14. An image processing system comprising:
an image processing apparatus that performs printing based on a user operation,
wherein the image processing apparatus includes a configuration included in the image processing apparatus according to claim 1.

15. An image processing system comprising:
an image processing apparatus that performs printing based on a user operation,
wherein the image processing apparatus includes a configuration included in the image processing apparatus according to claim 2.

16. An image processing system comprising:
an image processing apparatus that performs printing based on a user operation,
wherein the image processing apparatus includes a configuration included in the image processing apparatus according to claim 3.

17. An image processing system comprising:
an image processing apparatus that performs printing based on a user operation,
wherein the image processing apparatus includes a configuration included in the image processing apparatus according to claim 4.

18. The image processing system according to claim 14,
wherein a conversation partner of the user is either one of the image processing apparatus and a remote terminal operated by the user.

19. A non-transitory computer readable medium storing a program causing a computer to execute a process, the computer controlling an image processing apparatus which performs printing based on an operation of a user, the process comprising:
extracting the user's intention about a print setting from conversation data between the user and a conversation partner; and
proposing, to the user, information about change of the print setting, the change being inferred from the extracted intention.

20. An image processing method for controlling an image processing apparatus which performs printing based on an operation of a user, the method comprising:
extracting the user's intention about a print setting from conversation data between the user and a conversation partner; and
proposing, to the user, information about change of the print setting, the change being inferred from the extracted intention.
